(19) United States
(12) Patent Application Publication
(10) Pub. No.: US 2007/0114754 A1
(43) Pub. Date: May 24, 2007

(54) Shock absorber system for manual wheelchair

(76) Inventors: Dominador Tomaclas Santos JR., Chicago, IL (US); Rosanna Santos Estrada, Chicago, IL (US)

Correspondence Address: DOMINADOR T. SANTOS, JR., 2858 W. ADDISON AVE., CHICAGO, IL, 60618, US

(21) Appl. No.: 11/412,131

(22) Filed: Apr. 27, 2006

Related U.S. Application Data
(60) Provisional application No. 60/594,670, filed on Apr. 27, 2005.

(51) Int. Cl. B62M 1/14

(52) U.S. Cl. 280/304.1; 280/250.1

(57) ABSTRACT

This invention provides the patient-user of wheelchair a very comfortable ride especially to persons with back pains, injuries and other type of disabilities. This comes in a kit and can be readily fitted into both new wheelchairs and into after-market ones owned by individuals, hospitals, nursing homes, rehab facilities, airports, hotels, restaurants, etc. It can be installed by anybody since an easy-to-follow instructions and diagrams are included in the kit. The rear wheels are separately provided with shock absorber system. Therefore each wheel has its own suspension that works separately or jointly with its pair.

This invention relates to a shock absorber system for a manual wheelchair. The invention consist of the following components:

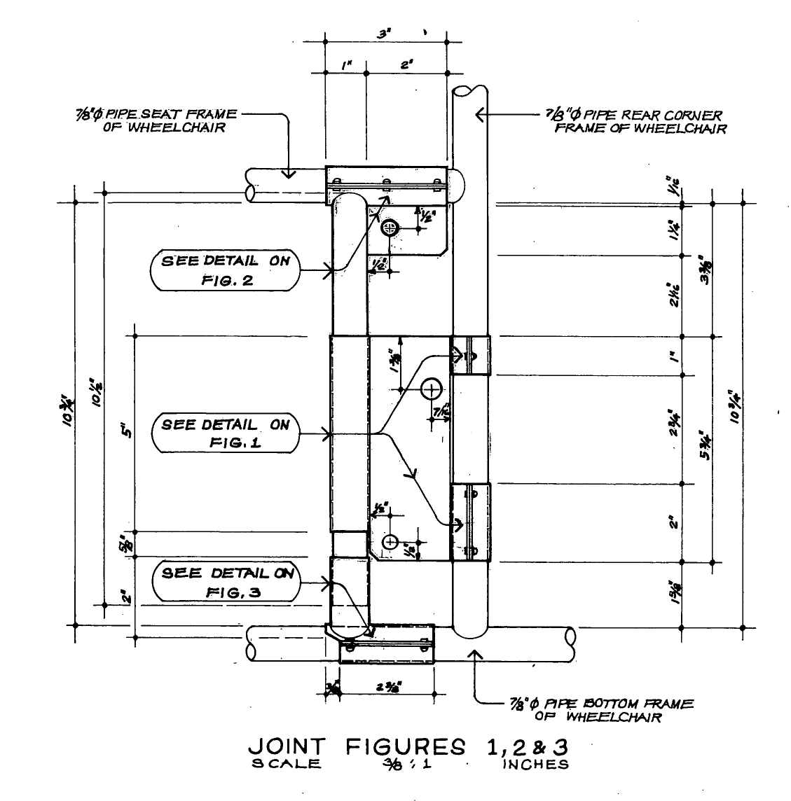

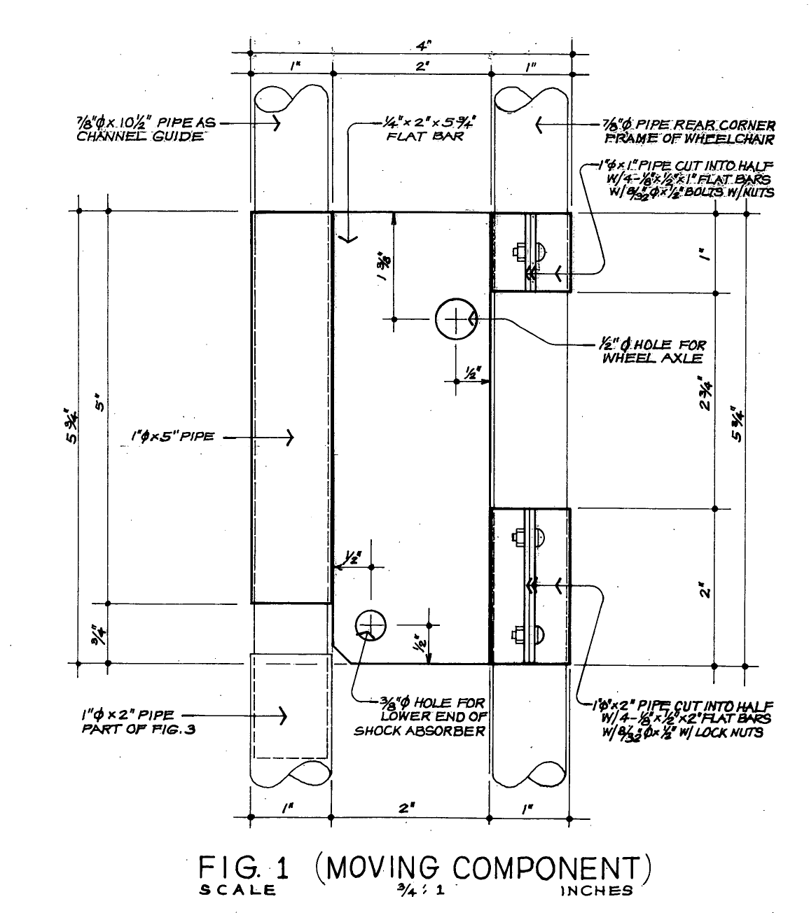

### BRIEF DESCRIPTION OF FIG. 1 (MOVING COMPONENT)

This component of the shock absorber system is so designed to move up and down making use of the vertical wheelchair corner frame ⅞″ dia pipe and the fabricated vertical telescoping ⅞″ dia and 1″ dia joints as its channels or guides. The main wheel is relocated from the wheelchair vertical corner frame pipe to the ¼″ thick flat bar and being held by its ½″ dia×5″ axle bolt. A combination of hydraulic and spring type shock absorber is installed in this moving component so that shocks and vibrations are taken cared of. The bottom end of the shock absorber is attached to the ¼″×2″×5¾″ moving flat bar while its upper end is attached to the fixed upper ¼″×1¼″×2″ flat bar which are both held by ⅜″ dia×2″ fine thread machine bolts.

1. Materials and Specifications:

a) All materials are made of aircraft grade aluminum except bolts, washers, nuts and shock absorbers. Materials and specifications used herein are based on one side only of the wheelchair.

b) One (1) piece of ¼″×2″×5¾″ aluminum flat bar with two (2) drilled holes; One (1) whole piece of 1″ dia×5″ pipe; One (1) cut into half lengthwise 1″ dia×1″ pipe; One (1) cut into half lengthwise 1″ dia×2″ pipe; Four (4) pieces of ⅛″×½″×1″ flat bars; Four (4) pieces ⅛″×½″×2″ flat bars and Six (6) sets of 8/32″ dia×½″ half round head bolts, lock washers and nuts; One (1) piece ½″ dia×1½″ metal bushing; One (1) piece ½″ dia locknut; One (1) piece ⅜″ dia×2″ fine threads machine bolts; and One (1) piece ⅜″ dia×⅜″ metal bushings and two (2) pieces ⅜″ dia locknuts.

c) The aluminum ¼″×2″×5¾″ flat bar has two (2) drilled holes. One is of ½″ dia for the main axle which is located at 1⅜″ from the top line of the upper right corner downward of the flat bar and 7/16″ from the right edge inward. This is where the ½″ dia×5″ bolt or axle go through which holds the larger wheel in place. Another drilled hole is a ⅜″ dia which is located at ½″ from the bottom line upward of the flat bar left corner and ½″ from the left edge inward. A ⅜″ dia×2″ hexagonal head fine thread machine bolt go through it that holds the lower end of the shock absorber.

d) Welded vertically along the left edge at 5¾″ length of the ¼″×2″×5¾″ flat bar is a whole piece of 1″ dia×5″ pipe which upper end is vertically aligned and leveled to the top left upper corner downward. This whole piece of 1″ dia×5″ pipe is where the ⅞″ dia×10½″ whole pipe that goes through it, which serves as a channel or guide for the moving component.

e) At the opposite right upper corner of the ¼″×2″×5¾″ flat bar, a cut into half lengthwise 1″ dia×1″ pipe is aligned and welded from the top line of the flat bar edge downward along its 5¾″ length. Its longitudinal edges are fitted with four (4) pieces of ⅛″×½×1″ flat bars with a drilled 8/32″ dia hole in each pair and welded vertically into the cut edges of the said pipe. It is then secured by one (1) set of 8/32″ dia×½″ half round head bolt, lock washer and a nut that clasps very loosely to the corner vertical wheelchair frame ⅞″ dia pipe so that the moving component can freely move up and down.

f) Another cut into half lengthwise 1″ dia×2″ pipe is aligned and welded from the bottom right corner line upward along its length of 5¾″ of the ¼″×2″×5¾ flat bar. It is vertically welded and aligned to the welded upper cut into half lengthwise 1″ dia×1″ pipe. Its longitudinal edges are fitted with four (4) pieces of ⅛″×½″×2″ flat bars with couple of drilled 8/32″ dia holes in each pair and then welded vertically along the cut edges of the said pipe. It is then secured by two (2) sets of 8/32″ dia×½″ half round head bolts, lock washers and nuts that clasps very loosely to the corner vertical wheelchair frame ⅞″ dia pipe so that the moving component can freely move up and down.

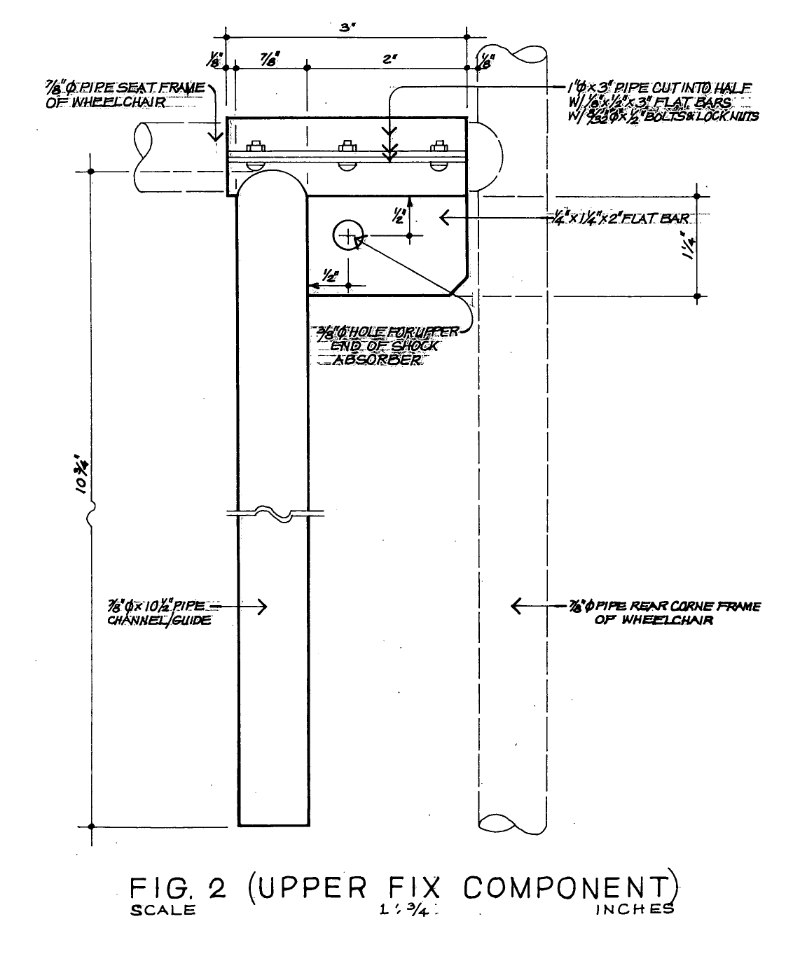

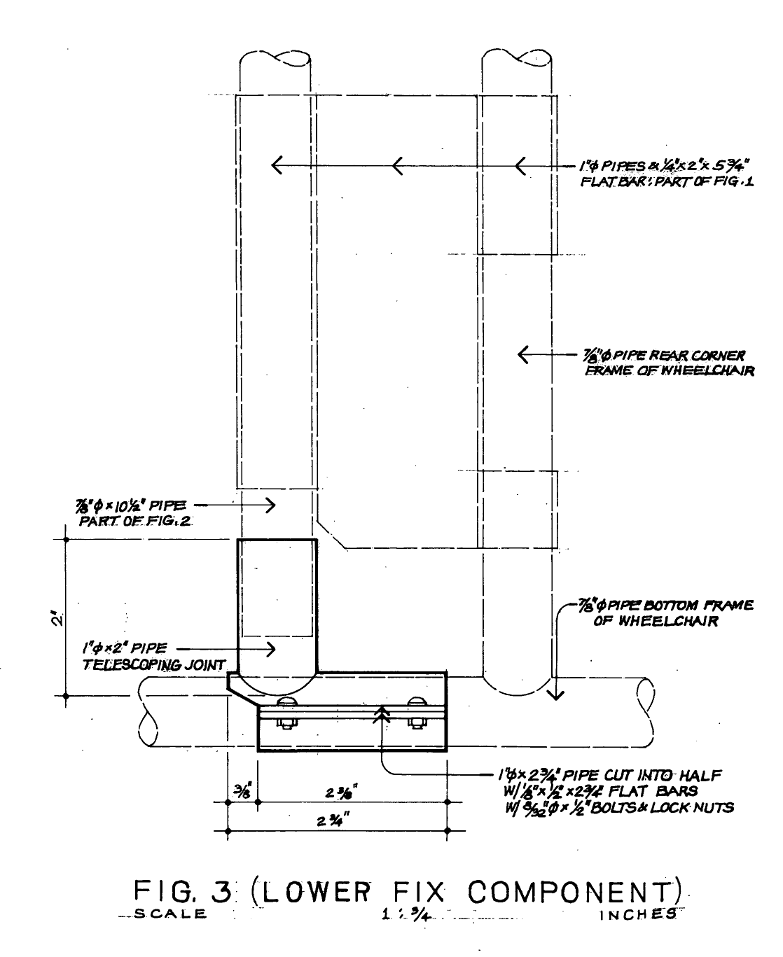

### BRIEF DESCRIPTION OF FIG. 2 (UPPER FIXED COMPONENT

This component of the shock absorber system is so designed to serve as a guide or channel for the up and down function of the moving component installed directly under it. Part of the channel is a ⅞″ dia×10½″ whole pipe to compliment the wheelchair rear vertical frame corner pipe. It has a ¼″×1¼″×2″ flat bar where a ⅜″ dia×2″ machine bolt go through it that holds the upper end of the shock absorber. A cut into half lengthwise 1″ dia×3″ pipe aligned and horizontally welded along the top line of the 2″ width of the ¼″×1¼″×2″ flat bar, also aligned and welded in a right angle with the top end of the ⅞″ dia×10½″ vertical pipe. The cut into half lengthwise pipe fitted and welded longitudinally with 4 pieces of ⅛″×½″×3″ flat bars, clasps tightly to the ⅞″ dia horizontal wheelchair seat frame pipe and secured with bolts, lock washers and nuts. It is so aligned perfectly with the lower fixed component and both ⅞″ dia installed and ⅞″ dia wheelchair vertical frame corner pipes that serves as channels so as to enhance the smooth up and down function of the moving component.

1. Materials and Specifications:

a) All materials are made of aircraft grade aluminum except bolts, washers, nuts and shock absorbers. Materials and specifications used herein are based on one side only of the wheelchair.

b) Aluminum flat bar ¼″×1¼″×2″; One (1) whole piece of ⅞″ dia×10½″ pipe; One (1) piece cut into half lengthwise 1″ dia×3″ pipe; Four (4) pieces ⅛″×½″×3″ flat bars; Six (6) sets of 8/32″ dia×½″ half round head bolts; lock washers and nuts.

c) The ¼″×1¼″×2″ flat bar has a drilled ⅜″ dia hole located at ½″ from the top line of left upper corner downward and ½″ from the left edge inward. At the same left upper corner of the flat bar, a whole piece of ⅞″ dia×10½″ pipe which upper end is aligned from the top line and welded vertically downward along the 1¼″ left edge and perfectly aligned vertically parallel with the corner frame pipe of the wheelchair. The upper end of the ⅞″ dia×10½″ pipe is shaped and welded in a right angle into the cut into half lengthwise 1″ dia×3″ pipe. The remaining 2″ length of the cut into half lengthwise 1″ dia×3″ pipe is perfectly aligned and horizontally welded along the 2″ wide top line of the ¼″ thick flat bar. The ⅞″ dia×10½″ vertical pipe and the cut into half lengthwise 1″ dia×3″ pipe are perfectly aligned and welded in a right angle at the upper left corner of the ¼″×1¼″×2″ flat bar. The longitudinal edge of the cut into half lengthwise 1″ dia×3″ pipe is then fitted and welded with four (4) pieces of ⅛″×½″×3″ flat bars that has three pairs of 8/32″ dia drilled holes. It is then secured with six (6) sets of 8/32″ dia×½″ half round head bolts, lock washers and nuts to clasp tightly the ⅞″ dia horizontal seat frame pipe of the wheelchair.

d) The above described whole piece of ⅞″ dia 10½″ pipe goes through the whole piece of 1″ dia×5″ pipe which was welded along the left edge of the ¼″×2″×5¾″ flat bar and part of the moving component. The ⅞″ dia×10½″ pipe serves as a complimentary channel or guide with the vertical corner wheelchair frame pipe. Because both pipes runs parallel and aligned perfectly, it helps provide the smooth up and down function of the moving component. The bottom end of the shock absorber is hooked up to the moving component with ⅜″ dia×2½″ machine bolt which go through the ¼″ thick flat bar.

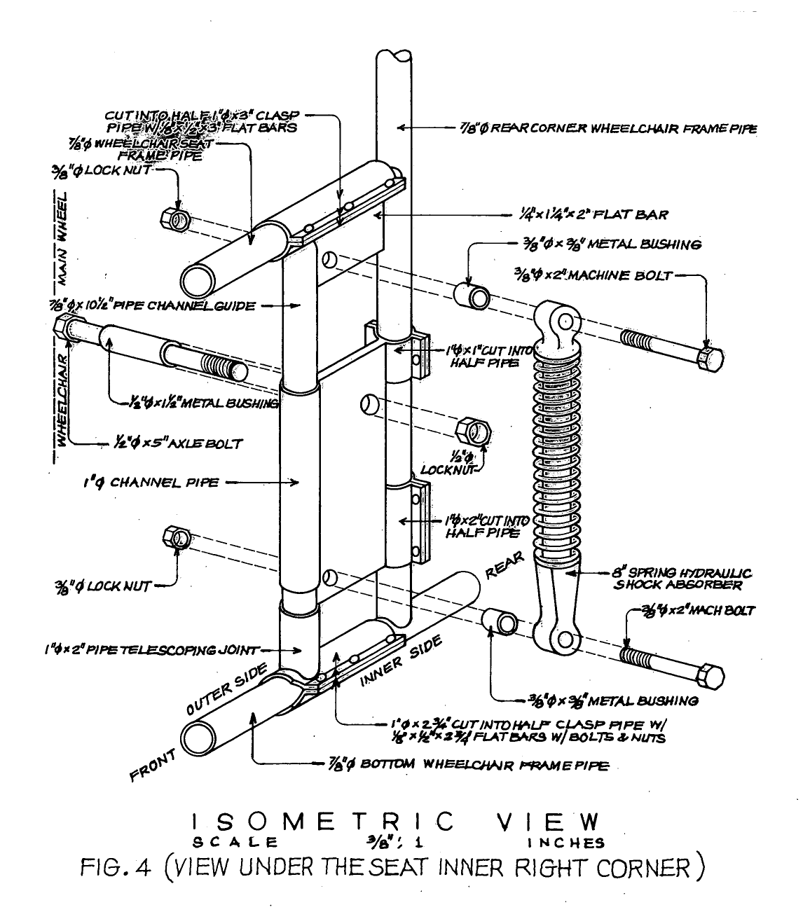

### BRIEF DESCRIPTION OF FIG. 3 (LOWER FIXED COMPONENT)

This component of the shock absorber system is so designed to serve as a fixed device that clasps tightly into the ⅞″ dia horizontal wheelchair bottom frame pipe. The clasp is made of cut into half lengthwise 1″ dia×2¾″ pipe with welded ⅛″×½″×2¾″ flat bars and secured with 8/32″ dia×½″ bolts, lock washers and nuts. Welded in a right angle towards the left end of the upper portion of the pipe clasp is a 1″ dia×2″ whole pipe which serves as the telescoping joint with the upper ⅞″ dia×10½″ vertical channel pipe that is part of the upper fixed component. It is aligned perfectly with the upper fixed component, with both ⅞″ dia installed and ⅞″ dia wheelchair vertical corner pipes as channels. This is to enhance the smooth up and down function of the moving component.

1. Materials and Specifications:

a) All materials are made of aircraft grade aluminum except bolts, washers, nuts and shock absorbers. Materials and specifications used herein are based on one side only of the wheelchair.

b) One (1) whole piece of 1″ dia×2″ pipe; One (1) piece cut into half lengthwise 1″ dia×2¾″ pipe; Four (4) pieces of ⅛″×½″×2¾″ flat bars with four (4) pairs of drilled 8/32″ dia holes and four (4) sets of 8/32″ dia×½″ half round head bolts, lock washers and nuts.

c) The whole piece of 1″ dia×2″ pipe is the telescoping link with the whole piece of ⅞″ dia×10½″ pipe that is part of the upper fixed component. The bottom end of the 1″ dia×2″ pipe is shaped, aligned perfectly and welded in right angle towards the left upper end of the cut into half lengthwise 1″ dia×2¾″ pipe. Both ⅞″ dia and 1″ dia pipes are perfectly aligned and vertically parallel to the wheelchair corner frame pipe. The longitudinal edges of the cut in to half of 1″ dia×2¾″ pipe is then fitted and welded horizontally with four (4) pieces of ⅛″×½″×2¾″ flat bars. These flat bars have four (4) pairs of drilled 8/32″ dia holes and secured with four (4) sets of 8/32″ dia×½″ half round-head bolts, lock washers and nuts that clasps tightly into the ⅞″ dia horizontal wheelchair bottom frame pipe.

d) The telescoping vertical joint of both upper ⅞″ dia and lower 1″ dia pipes is the determining factor relative to the height differences between the upper and lower horizontal wheelchair frame pipes. The ⅞″ dia×10½″ upper vertical pipe has to be adjusted in length where the height is shorter than what was designed originally for the installation of the shock absorber system, where the horizontal seat pipe and bottom horizontal frame pipe are closer.

### BRIEF DESCRIPTION OF THE SHOCK ABSORBER

The shock absorber to be used is the combination of spring and hydraulic type like the ones used on the rear wheels of a motorcycle. The upper end is held by a ⅜″ dia×2″ machine bolt that go through the ¼″ thick flat bar which is part of the upper fixed component. The lower end is also held by a ⅜″ dia×2″ machine bolt that go through the ¼″ thick flat bar which is part of the moving component. Whenever the load or weight of the person to use the wheelchair is greater than the normal capacity as designed originally, a heavy duty shock absorber shall be used instead.

### BRIEF DESCRIPTION OF HOW THE SHOCK ABSORBER SYSTEM WORKS

The wheelchair's main wheels which rolls over through uneven surfaces or pavements transmits back to the wheelchairs structural frame all the shocks and vibrations which is passed on obviously to the person sitting or riding the wheelchair. Originally the main wheels of the wheelchair are held by ½″ dia×5½″ axle-bolt which is attached through the vertical corner frame pipe of the manual wheelchair. Therefore there is no spring-like or shock-absorbing effect once the wheels roll over uneven surfaces or pavement.

With the invention of the Shock Absorber System installed into the manual wheelchair, shocks and vibrations are minimized if not eliminated at all. The vibrations and shocks encountered by the main wheels which are relocated with its axle and fixed through the moving component, are taken cared of by the shock absorber that is attached to the moving component. Therefore the shocks and vibrations encountered by the wheels which are caused by bumpy or uneven surfaces and pavements are no longer felt by the wheelchair passenger or patient in as much as its is already taken cared of by the Shock Absorber System.

Primarily my invention is designed to be fitted into a manual wheelchair. It may likewise be used and fitted into a powered wheelchair with similar structure like the manual wheelchair. Hence, the shock absorber to be used is different from the primary design. It may be exposed should there be not enough room under the seat. The moving and fixed components may vary from the original design in length, shape number and its installations, but the strength and quality of materials to be used are all the same.

This invention can be mass-produced after a fabricated prototype model shall have passed a series of tests with very good results. It will come in a kit with a do-it-yourself installation instructions and diagrams to meet the needs of the after market sale of a wheelchair. Wheelchair manufacturers or entrepreneurs with keen interest to this invention are most likely the ones to provide the technology and its production and marketing after a business contact with the inventor shall have been made.

What is claimed is:

1. A device with shock absorber system for a manual wheelchair, which minimizes if not eliminates shocks and vibrations while moving around on areas with uneven or bumpy surfaces and pavements.
